(19) United States
(12) Patent Application Publication
(10) Pub. No.: US 2025/0091044 A1
(43) Pub. Date: Mar. 20, 2025

(54) Sample Spreading and Loading Layer for Dry Slide

(71) Applicant: IDEXX LABORATORIES, INC., Westbrook, ME (US)

(72) Inventors: Paige Pomeroy, Westbrook, ME (US); Adam St. Hilaire, Westbrook, ME (US); Christopher Duffey, Westbrook, ME (US); Pamela Cacavas, Westbrook, ME (US)

(21) Appl. No.: 18/886,870

(22) Filed: Sep. 16, 2024

Related U.S. Application Data
(60) Provisional application No. 63/582,517, filed on Sep. 14, 2023.

(51) Int. Cl. B01L 3/00

(52) U.S. Cl. CPC B01L 3/502707; B01L 2200/16; B01L 2300/168

(57) ABSTRACT

Highly reflective, low density, permeable spreading layers for the transport, manipulation and analysis of liquid are provided, as well as articles that incorporate one or more of such permeable spreading layers and related methods.

### FIELD

The present disclosure relates to a highly reflective, low density, permeable spreading layer for the transport, manipulation and analysis of liquids, including the clinical analysis of biological liquids.

### BACKGROUND

Analytical assays and analyses are commonly performed on many kinds of liquid samples, including aqueous biological fluids like blood, plasma, serum, urine, cerebrospinal fluid, and more. Wet chemistry-based techniques, where reaction reagents are in liquid form, are used for many analytical assays, but dry chemistry, in which reagents are present in a dry form in, e.g., a reaction vessel or in one or more layers on a support, has been established to meet many laboratory needs, including providing accurate, reproducible results rapidly with minimal operator involvement and minimal sample volume.

For optimal results, layer-based dry chemistry requires effective spreading and distribution of a sample applied to a layer so that as the sample migrates to one or more layers beneath the application layer, exposure of one or more analytes in the sample to any reagents present in the layers is homogeneous. For a layer to receive, and then spread and distribute a sample to layer(s) below, it must be permeable, i.e., have pores through which the sample can flow.

To create a permeable (i.e., porous) spreading layer that spreads, distributes and transmits samples to subordinate layer(s), particulate matter is often combined with a binder and deposited as a layer. Polymeric particles are most commonly used because of their compatibility with the binder systems, modest density (around 1 g/cm³), and their controlled particle size and particle size distribution. However, polymeric particles have drawbacks, including low reflectivity, a lack of mechanical robustness in the manufacture of layers, and environmental concerns.

Other non-organic particles have been used for spreading layers, including minerals (e.g. TiO₂, BaSO₄, CaCO₃) and solid glass spheres. Some of these particles provide functional benefits, such as high reflectivity for TiO₂, but they also present challenges with respect to manufacturing (e.g., poor coat-ability and process control due to small particle sizes and high density). Mixtures of inorganic pigments and polymeric particles are commonly used in an attempt to balance the disadvantages of each with mixed results.

### SUMMARY

The present disclosure provides permeable spreading layers that effectively distribute and transport aqueous samples, while also possessing, e.g., substantial reflectivity, resistance to mechanical failure and conduciveness to formation of homogenous layers during manufacture, and minimizing or eliminating environmental concerns.

The present disclosure provides a permeable spreading layer for the transport, manipulation and analysis of liquids, including the clinical analysis of biological liquids. One aspect of the disclosure provides a permeable spreading layer that includes hollow glass microspheres and a polymeric binder, in which the polymeric spreading layer has high reflectivity and low density. In some embodiments, the polymeric binder includes an emulsified polymer or copolymer with adhesive properties. In certain embodiments, the dry reflectivity, the wet reflectivity, or both, are high, and in embodiments higher than known spreading layers.

In some embodiments, the permeable spreading layer further includes one or more additional components, including buffers, surfactants, plasticizers, biocides, defoamers, pigments, and voiding agents.

### BRIEF DESCRIPTION OF THE DRAWINGS

The features, objects and advantages other than those set forth above will become more readily apparent when consideration is given to the detailed description below. Such detailed description makes reference to the following figures, wherein:

FIG. 1 shows a TEM image of a cross-section of a slide with the sample loading and spreading layer (SLS) as the top layer.

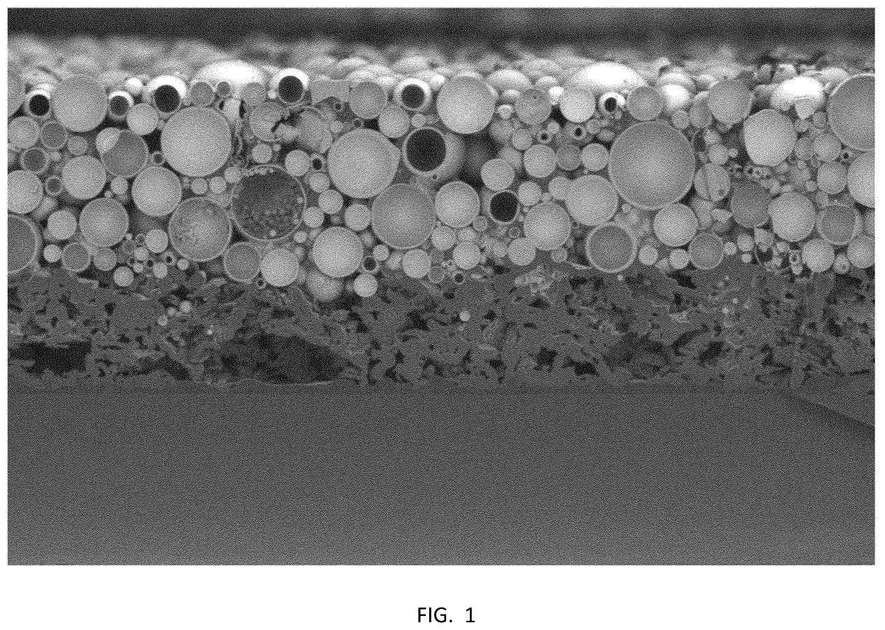

FIG. 2 shows a TEM image of a top-down view of a slide with the sample loading and spreading layer (SLS) as the top layer.

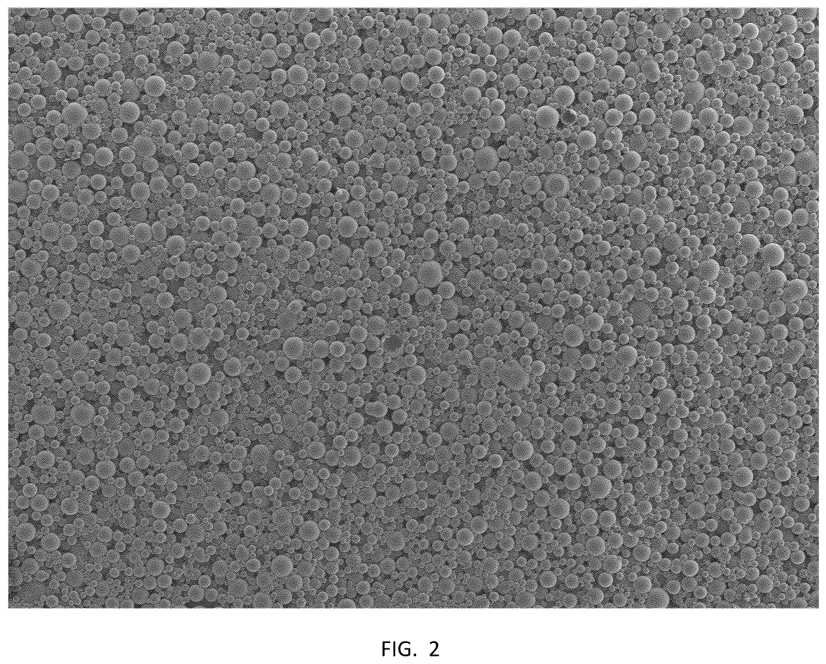

FIG. 3 shows a graph of incremental intrusion vs pore size utilizing mercury intrusion porosimetry on an embodiment of the disclosure.

FIG. 4 shows a graph of log differential intrusion vs pore size utilizing mercury intrusion porosimetry on an embodiment of the disclosure.

FIG. 5 shows a graph of incremental intrusion vs pore size utilizing mercury intrusion porosimetry on a control embodiment.

FIG. 6 shows a graph of log differential intrusion vs pore size utilizing mercury intrusion porosimetry on a control embodiment.

FIG. 7 shows a graph of the mean absolute reflectance of the coated spreading layer containing hollow glass microspheres (solid line) compared to a coated spreading layer with crosslinked polystyrene microspheres (dashed line).

While the present methods and compositions are susceptible to various modifications and alternative forms, exemplary embodiments thereof are shown by way of example in the drawings and are herein described in detail. It should be understood, however, that the description of exemplary embodiments is not intended to limit the devices and methods to the particular forms disclosed, but, on the contrary, the intention is to cover all modifications, equivalents and alternatives falling within the spirit and scope of the devices and methods as defined by the embodiments herein and the claims below. Reference should therefore be made to the various aspects and embodiments herein and claims below for interpreting the scope of the devices and methods.

### DESCRIPTION

Herein, a permeable spreading layer is provided for the transport, manipulation and analysis of liquids. A permeable spreading layer is a layer that can accept a liquid sample, whether applied directly to the permeable spreading layer (e.g. by a user or automated sample analyzer) or provided to it from a layer or layers in fluid contact with the spreading layer. Within the permeable spreading layer, the liquid sample is distributed such that a uniform apparent concentration of each substance within the sample is provided at the surface of a layer in fluid contact with the permeable spreading layer. Such an apparent concentration can be achieved with concentration gradients present through the thickness of or otherwise in the permeable spreading layer. Such gradients do not present any difficulty to obtaining quantitative test results and can be accommodated using known calibration techniques.

A number of terms are introduced below:

Herein, “sample” and “liquid sample” refers to a volume of fluid for analysis using dry chemistry. The fluid may be processed prior to analysis by dry chemistry (e.g., by absorption, adsorption, chromatography, distillation, extraction, ion exchange, filtration, complex formation, crystallization, centrifugation, drying, lysing, supplementing, and the like). A “sample” includes pre-processed or unprocessed fluids that are directly applied by a user or automated sample analyzer to a permeable spreading layer or to a dry chemistry analytical element (comprising two or more layers, one of which is a permeable spreading layer of the disclosure). A sample also includes as fluids that pass from one layer to another within a dry chemistry analytical element. Samples may comprise one or more “substances”, including analytes, reagents, precursors, cofactors, enzymes, catalysts, non-enzymatic proteins, buffers, salts, and the like, any of which may facilitate, impede or have no effect on the analysis of the fluid.

The term “about” means plus or minus 10% of the recited measurement. Unless specifically stated to the contrary, for ranges specified using “about” language, the about applies to both ends of the recited range whether specified or not. For example, “about 87% to 97%” is equivalent to “about 87% to about 97%”.

Recitation of ranges of values herein are merely intended to serve as a shorthand method of referring individually to each separate value falling within the range, unless otherwise indicated herein, and each separate value is incorporated into the specification as if it were individually recited. For example, if a concentration range is stated as 1% to 50% (or degrees, mass amounts, and the like), it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

Disclosed herein are aspects and embodiments of permeable spreading layers. In one aspect, the disclosure provides a permeable spreading layer including hollow glass microspheres, and a polymeric binder. In embodiments, the polymeric spreading layer has high reflectivity and low density, and in embodiments, the polymeric binder includes an emulsified polymer or copolymer with adhesive properties. Further embodiments and characteristics of the permeable spreading layer of the disclosure follow.

In some embodiments, the permeable spreading layers of the description are “isotropically permeable” or “isotropically porous”; whereas, in some embodiments, the permeable spreading layers of the description are anisotropically permeable or porous. Such terms refer to the regularity of the porosity in all directions within the structure of a permeable spreading layer.

In one aspect, particulate material can be used to form such a permeable spreading layer and provide porosity, wherein the porosity is created by interconnected spaces between the particles. Various types of particulate matter have been used previously, including pigments (e.g., titanium dioxide, barium sulfate, zinc oxide, and the like), diatomaceous earth and microcrystalline colloidal materials (e.g., microcrystalline cellulose), and spherical particles of uniform size (e.g., polymeric beads). In some embodiments herein, however, hollow glass microparticles or microspheres (“HGM”) are the primary particulate material used for permeable spreading layers. Hollow glass microspheres can also include different kinds of glass, e.g., soda-lime glasses, borosilicate glasses, lead glasses, aluminosilicate glasses, oxide glasses, glass ceramic glasses, non-silicate glasses, and polymer glasses, as well as other materials that possess physical properties similar to hollow glass microspheres (e.g., density, reflectivity), and combinations thereof. Additional related disclosure is provided elsewhere herein.

The degree of porosity can vary depending on, e.g., pore or void size, pore or void volume, or other parameters. The interconnected void spaces existing among the adjacent particles of the permeable spreading layer provide for transport of liquids and for substances that are contained in a sample or introduced into the sample as it is transported through the structure.

The void spaces in the permeable spreading layer represent a void volume within the range of from about 10 to 80 percent. Where it is desired to increase void volume, spreading layers can contain particulate structures having void volumes within the range of from about 40 to 80 percent. In embodiments, the average void volume of the polymeric spreading layer comprises between about 10 percent to about 80 percent, about 20 percent to about 80 percent, about 30 percent to about 80 percent, or about 40 percent to about 80 percent. The presence of these interconnected void spaces provide paths through which a fluid sample can flow.

The average size of void spaces of the disclosure is small in absolute terms but comparatively large on a molecular scale. The effective mean void size exhibited by the permeable spreading layers of the disclosure is typically within about 0.01-1× the mean particle size of the hollow glass microspheres used to make a permeable spreading layer. Thus, liquid transport is facilitated by the capillary action of the liquid being drawn through these interconnected spaces within the particulate structure of the spreading layer. In some embodiments, the median pore or void size is between about 0.1 and 50 μm. In some embodiments, the median pore or void size is between about 0.1 and 25 μm. In some embodiments, the median pore or void size is between about 1 and 50 μm. In some embodiments, the median pore or void size is between about 1 and 25 μm.

The size of the void spaces and the void volume of the particulate structure can vary widely and will depend upon a number of factors including the size of the hollow glass microspheres contained in the structure, the method of preparing the structure, the presence of additional particulate matter and its size, and the like.

For example, In some embodiments that include hollow glass microspheres and one or more additional particulate materials, e.g., pigments, the average size of void spaces is affected by the mean particle size of the hollow glass microspheres and the one or more additional particulate materials. That is, the average void space size in a permeable spreading layer made with hollow glass microspheres of a 60 micron mean diameter is typically reduced when formulated with an additional particulate with a 10 micron mean diameter. Further detail concerning these various parameters is presented elsewhere herein. For any given spreading layer, the desired size of these void spaces will depend upon the particular liquid sample to be transported. That is, sample viscosity and the size and molecular characteristics of various substances originally contained in the sample or introduced into the sample, affect the selection of appropriate void space size.

The size of void spaces in the particulate structures can be measured by conventional techniques, such as gas sorption, liquid intrusion (e.g., mercury intrusion), x-ray and neutron scattering, and forms of microscopy, among others.

In some embodiments, permeable spreading layers spread a sample in two dimensions along the plane of the spreading layer. For example, if a sample is applied to a first side of a spreading layer from a pipette tip with a drop diameter of 3 mm, the spreading layer can increase the area of the sample that emerges from a second, opposite, side of the spreading layer. For example, the area of the applied sample can increase, e.g., from 2-fold to 100-fold. In some embodiments, the area of the sample applied on the first side can increase from about 4-fold to 50-fold, and in some embodiments, the area of the sample applied on the first side can increase from about 4-fold to 20-fold.

In some embodiments, permeable spreading layers mix the substances in a sample during the passage of the sample from a first side of the spreading layer to a second, opposite, side of the spreading layer. For example, if a heterogeneous sample is applied to a first side of a spreading layer, the spreading layer can decrease heterogeneity of the sample that emerges from a second, opposite, side of the spreading layer.

In some embodiments, the permeable spreading layers of the disclosure can meter or distribute an applied sample. That is, spreading layers can receive on a first surface an applied liquid sample and distribute the sample within itself such that a uniform concentration of the liquid sample and substances contained therein are provided at the opposite surface of the spreading layer. In some embodiments, extremely precise sample application techniques are not required as it is possible to obtain substantially uniform concentrations over a range of applied sample volumes.

The dry thickness of the permeable spreading layer can vary widely depending upon the size of the hollow glass microspheres, and the specific use for which the spreading layer is intended. For embodiments that includes a support structure for the permeable spreading layer, the dry thickness of the permeable spreading layer is within the range of from about 100 to about 400 microns. However, in certain applications, structures having a thickness outside the aforementioned range may also be employed.

Hollow glass microparticles in unmodified form are typically not naturally adherent to each other or to, e.g., an adjacent layer in a dry chemistry analytical element. If a particulate matter is not adherent, it can be treated to obtain particles that can adhere to each other at points of contact and thereby facilitate formation of a permeable spreading layer. As an example of suitable treatment, non-adherent particles can be coated with a thin adherent layer, such as a polymeric binder, and formed into a layer. When the binder coating dries, layer integrity is maintained and open, void spaces remain between its component particles.

Suitable binders and binder systems include acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, styrene butadiene copolymers or blends, polyethylene, ethylene/propylene copolymer, polyvinyl acetate (PVA), ethylene-vinyl acetate (EVA), PVA-EVA copolymers, ethylene vinyl alcohol copolymer, polyvinylpyrrolidone, polyurethanes, poly(lactic acid), copolyesters, and mixtures thereof.

Relative concentrations of binders (and, optionally, viscosity modifiers, plasticizers, biocidal components, lubricants, defoaming agents, etc,) to elements that do not change form (such as melt-flow/film-form) or evaporate during the coating and drying process are defined by the pigment volume concentration (PVC). PVC is a well-known measurement in coating formulation to determine how much binder and “pigment” (where “pigment” is defined as particles, fillers, or other element unchanged during the coating and drying process) should be incorporated into the formulation to achieve a particular porosity in a coating. Typically, porous coatings have a pigment volume concentration >85%, as defined by the equation PVC=[ΣVp/(ΣVp+ΣVb)]×100% where ΣVp is the sum of the volumes of all “pigments” in the system and ΣVb is the sum of the volumes of all binders in the system. One of skill in the art knows that compatible binder-particle systems should be selected, where the properties of the binder are compatible with the surface chemistry of the pigment (i.e., particle, filler, etc).

Herein, PVCs ranging from about 87% to 97% are suitable for the applications described herein for binders used in coatings that are of average strength or greater; weaker binders can support lower PVCs than strong binders. In certain some embodiments, the favorable PVC is about 93%. Binder strength also impacts robustness of the coating to manufacturing stress. In some embodiments, the PVC of the permeable spreading layer is about 87% to 97%, including, e.g., about 87% to 93%, about 89% to 97%, about 90% to 95%, about 91% to 96%, individually, by percentage, about 87% through 97%, and the like.

In some embodiments, the binder may be included in the permeable spreading layer in any amount to obtain the desired properties. For example, in one embodiment the binder is included in an amount of about 0.1% to 10% by weight, or from about 0.5% to 9% by weight, or from about 1.0% to 8% by weight, or from about 1.5% to 7% by weight, or from about 2.0% to 7% by weight, or from about 2.5% to 7% by weight, or from about 3.0% to 6% by weight, or from about 0.5% to 8% by weight, or from about 0.5% to 6% by weight, or from about 1.5% to 8% by weight, or from about 2.5% to 6% by weight, or from about 1.0% to 5% by weight, or from about 3% to 10% by weight, or from about 3.5% to 8% by weight, or from about 3% to 7%, or from about 4% to 10% by weight, or from about 4% to 8% by weight, or from about 4% to 6% by weight, and the like.

In embodiments, the permeable spreading layer includes combinations of favorable characteristics as described herein. For example, in some embodiments, the permeable spreading includes hollow glass microspheres having a crush strength of at least 250 psi, or have an average particle size of about 5 μm to 180 μm, or a density of 0.15 g/cc to 0.83 g/cc, and in some embodiments, hollow glass microspheres having a crush strength of at least 250 psi, an average particle size of about 5 μm to 180 μm, and a density of 0.15 g/cc to 0.83 g/cc. In other embodiments, the permeable spreading layer includes hollow glass microspheres having a crush strength of at least 500 psi, or have an average particle size of 20 μm to 65 μm, or a density of 0.3 g/cc to 0.6 g/cc, while in other embodiments, hollow glass microspheres having a crush strength of at least 500 psi, an average particle size of 20 μm to 65 μm, and a density of 0.3 g/cc to 0.6 g/cc.

In some embodiments, the permeable spreading layer includes between about 0.1-10 wt % of a polymeric binder composition including one or more acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, styrene butadiene copolymers or blends, polyethylene, ethylene/propylene copolymer, polyvinyl acetate (PVA), ethylene-vinyl acetate (EVA), PVA-EVA copolymers, ethylene vinyl alcohol copolymer, polyvinylpyrrolidone, polyurethanes, poly(lactic acid), copolyesters, or mixtures thereof; and hollow glass microspheres that are present at between about 1-80 wt %. In some embodiments, the polymeric binder is present at between about 2-8 wt %; and the hollow glass microspheres are present at between about 10-60 wt %, while in some embodiments, the polymeric binder is present at between about 2-8 wt % and the hollow glass microspheres are present at between about 20-50 wt %. In other embodiments, the polymeric binder is present at between about 3-7 wt %; and the hollow glass microspheres are present at between about 25-45 wt %, while in other embodiments, the polymeric binder includes acrylic polymers, polyvinyl acetate (PVA) polymers, ethylene-vinyl acetate (EVA) polymers, PVA-EVA copolymers, styrene butadiene copolymers or mixtures thereof, and is present at between about 5-6 wt %; and the hollow glass microspheres are present at between about 30-40 wt %. In some embodiments, the permeable spreading layer includes hollow glass microspheres at between about 1-80 wt %, and a pigment volume concentration (PVC) of between about 87% to 97%. In some embodiments, the hollow glass microspheres are present at between about 10-60 wt %; and the PVC is between about 87% to 97%, while in some embodiments, the hollow glass microspheres are present at between about 20-50 wt %; and the PVC is between about 87% to 97%. In other embodiments, the hollow glass microspheres are present at between about 25-45 wt %; and the PVC is between about 87% to 97%, while in some embodiments, the polymeric binder includes acrylic polymers, polyvinyl acetate (PVA) polymers, ethylene-vinyl acetate (EVA) polymers, PVA-EVA copolymers, styrene butadiene copolymers or mixtures thereof; the hollow glass microspheres are present at between about 30-40 wt %; and the PVC is between about 90% to 95%. In some embodiments, the polymeric binder includes one or more acrylic polymers or copolymers; the hollow glass microspheres are present at between about 30-40 wt %; and the PVC is between about 90% to 95%.

Permeable spreading layers can be prepared by coating with a colloid, suspension or dispersion mixture. The range of materials useful for inclusion in any permeable spreading layer is widely variable as discussed herein and will usually include predominantly materials that are resistant to, i.e., substantially insoluble in and non-swellable upon contact with water or other liquid under analysis. Swelling of about 5-25 percent of the layer's dry thickness may be normal. The thickness of the permeable layer is variable and depends on, e.g., the intended sample volume and the void volume of the permeable layer. Typically, the permeable layer is designed to be able to absorb the intended sample volume, so a permeable layer with a smaller void volume will be thicker than a layer with a larger void volume to absorb a given sample volume. Spreading layers of from about 100 μm to about 400 μm dry thickness (e.g., between about 100 μm to about 300 μm or about 125 μm to about 275 μm) are often suitable to absorb typical sample volumes. However, wider variations in thickness are acceptable and may be desirable for particular spreading layers, for example between about 100 μm to about 500 μm.

Permeable spreading layers of the disclosure can be preformed as a separate layer which can thereafter be laminated with one or more additional functional layers (e.g., reagent layer, filter layer, isolation layer, indicator layer, physical support layer, and the like) to produce a dry chemistry analytical element. Layers preformed as separate members, if coatable, are typically coated from solution or dispersion on a surface from which the layer can be physically stripped when dried.

An alternative, and more convenient, procedure is to sequentially coat each layer in a dry chemistry analytical element, from bottom layer to top layer, on a stripping surface or a support layer. Such coating can be accomplished in a continuous or discrete process using one or more coating technique, including knife-over-air coating (floating knife), knife-over-roll coating, roll coating, kiss coating, gravure coating, metering rod or Myer bar coating, comma direct coating, comma reverse coating, reverse roll coating, slot die coating, immersion or dip coating, and curtain coating, among others. Using hopper coating techniques, it is possible to coat adjacent layers simultaneously. If it is essential or desirable that adjacent layers be discrete, and maintenance of layer separation by adjustment of coating formulation is not satisfactory, as can be for permeable spreading layers, the appropriate selection of components for each layer, including solvent or dispersion medium, can minimize or eliminate unwanted interlayer component migration and solvent effects, thereby promoting the formation of well-defined, discrete layers. In addition, one or more layers can be dried for a time sufficient to prevent or minimize mixing with the subsequently coated layer. Any interlayer adhesion problems can be overcome by means of surface treatments.

Such dry chemistry analytical elements can comprise one or more permeable spreading layers in combination with one or more additional functional layers.

For example, for an embodiment that includes a support layer in the form of an optically transparent substrate, knife-over-air coating can be used to sequentially apply each layer. The knife-over-air coating process involves a knife or blade positioned vertically above the substrate which is being supported on either side by two rollers. Coating weights using this technique are derived from the distance between the two rollers and the tension of the substrate The blade can also be raised and lowered to apply additional tension to impact the coating weight and level of penetration, which will affect adhesion and handle. Knife-over-air coating involves the blade being positioned above the substrate, which is supported by a roller below. The blade can be raised or lowered to obtain different coating thicknesses, and the shape of the blade can be altered to complement the viscosity and rheology of the coating medium.

In some embodiments, the permeable spreading layer further comprises one or more components that alter or enhance function of the layer, including, e.g., viscosity modifiers (e.g., carboxymethyl cellulose), plasticizers (e.g., polyethylene glycol), biocidal components (e.g., Proclin), lubricants, defoaming agents (e.g., emulsified silicone), additional particles (or “pigments”) ranging from about 1-100 μm in size, and combinations thereof.

### Particles

In some embodiments, the particulate material used to form permeable spreading layer and provide porosity include hollow glass microspheres (also referred to as, e.g., glass bubbles, hollow glass spheres, balls, bubbles or micro-balloons). The hollow microspheres of the present disclosure are distinct from solid glass microspheres (or solid glass spheres, solid glass beads, etc.) in that the solid glass microspheres are significantly denser, significantly less reflective (and of a tan to yellow hue), and not hollow. The term “hollow glass microspheres” and its analogs can include different kinds of glass, e.g., soda-lime glasses, borosilicate glasses, lead glasses, aluminosilicate glasses, oxide glasses, glass ceramic glasses, non-silicate glasses, and polymer glasses, as well as other materials that possess physical properties similar to hollow glass microspheres (e.g., density, reflectivity), and combinations thereof.

In some embodiments, hollow glass microspheres may be included in the permeable spreading layer in any amount to obtain the desired properties. For example, in one embodiment, the hollow glass microspheres are included in an amount of 0.1 to 80 wt %, or from 1 to 80 wt %, or from 0.5 to 70 wt %, or from 1 to 60 wt %, or from 1 to 50 wt %, or from 1 to 40 wt %, or from 1 to 30 wt %, or from 1 to 20 wt %, or from 1 to 15 wt %, or from 1-10 wt %, or from 5 to 80 wt %, or from 5 to 70 wt %, or from 5 to 60 wt %, or from 5 to 50 wt %, or from 5 to 40 wt %, or from 5 to 30 wt %, or from 5 to 20 wt %, or from 5 to 15 wt %, or from 5-10 wt %, or from 10 to 80 wt %, or from 10 to 70 wt %, or from 10 to 60 wt %, or from 10 to 50 wt %, or from 10 to 40 wt %, or from 10 to 30 wt %, or from 10 to 20 wt %, or from 10 to 15 wt %, or from 20 to 80 wt %, or from 20 to 70 wt %, or from 20 to 60 wt %, or from 20 to 50 wt %, or from 20 to 40 wt %, or from 20 to 30 wt %, or from 30 to 80 wt %, or from 30 to 70 wt %, or from 30 to 60 wt %, or from 30 to 50 wt %, or from about 25% to 45%, or from 30 to 40 wt %, or from 40 to 80 wt %, or from 40 to 70 wt %, or from 40 to 60 wt %, or from 40 to 50 wt %, or from 50 to 80 wt %, or from 50 to 70 wt %, or from 50 to 60 wt %, or from 60 to 80 wt %, or from 60 to 70 wt %. In some embodiments, the hollow glass microspheres are included in an amount of 10 to 50 wt %. In some embodiments, the hollow glass microspheres are included in an amount of 15 to 45 wt %. In some embodiments, the hollow glass microspheres are included in an amount of 20 to 40 wt %. In some embodiments, the hollow glass microspheres are included in an amount of 70 wt % or greater. In some embodiments, the hollow glass microspheres are included in an amount of 60 wt % or greater. In some embodiments, the hollow glass microspheres are included in an amount of 50 wt % or greater. In some embodiments, the hollow glass microspheres are included in an amount of 40 wt % or greater. In some embodiments, the hollow glass microspheres are included in an amount of 30 wt % or greater. In some embodiments, the hollow glass microspheres are included in an amount of 20 wt % or greater. In some embodiments, the hollow glass microspheres are included in an amount of 10 wt % or greater. In some embodiments, the hollow glass microspheres are included in an amount of 5 wt % or greater.

In the present disclosure, suitable hollow glass microspheres are spherical microparticles typically ranging from about 1 μm to 300 μm in diameter. In some embodiments, the hollow glass microspheres have a particle size (D50 Micron or microns by volume) from about 1 to 200 μm, or from about 2 to 200 μm or from about 5 to 180 μm, or from about 15 to 135 μm. In some embodiments, the hollow glass microspheres have a particle size of about 1 to 120 μm, or about 10 to 110 μm, about 10 to 100 μm, or about 10 to 90 μm, or about 10 to 80 μm, or about 10 to 70 μm, or about 10 to 60 μm, or about 15 μm to about 100 μm, or about 15 μm to about 80 μm, or about 20 to 120 μm, or about 20 to 110 μm, or about 20 to 100 μm, or about 20 to 90 μm, or about 20 to 80 μm, or about 20 to 70 μm, or about 25 to 120 μm, or about 25 to 110 μm, or about 25 to 100 μm, or about 25 to about 90 μm, or about 25 to 80 μm, or about 25 to 70 μm, or about 25 to 60 μm, or about 12 to 40 μm, or about 12 to 30 μm, about 13 to 35 μm, about 15 to 30 μm, about 15 to 35 μm, or about 20 to 30 μm or about 20 to 40 μm.

In some embodiments, the hollow glass microspheres have a mean (average) or median particle size of about 5 μm, or about 10 μm, or about 15 μm, or about 20 μm, or about 25 μm, or about 30 μm, or about 35 μm, or about 40 μm, or about 45 μm, or about 50 μm, or about 55 μm, or about 60 μm, or about 65 μm, or about 70 μm, or about 75 μm, or about 80 μm, or about 85 μm, or about 90 μm, or about 95 μm, or about 100 μm, or about 105 μm, or about 110 μm, or about 115 μm, or about 120 μm.

In some embodiments, the glass microspheres of the present disclosure are hollow and comprise soda-lime-borosilicate glass (e.g., 3M™ Glass Bubbles). These hollow glass microspheres are low in density and lightweight, while retaining a high crush strength and resistance to shear, which allows them to be processed, e.g., through mixers and coaters without breaking to produce porous, permeable thin film coatings that have a significantly reduced density compared to standard particulate materials, e.g., pigments. The hollow glass microspheres in the present disclosure have a particle size distribution, surface area to volume ration and density conducive to forming homogeneous permeable spreading layers that avoid problems associated with other, denser particulates such as creaming, settling and dusting.

In some embodiments, the hollow glass microspheres have a crush strength of at least 250 psi or greater, or of at least 300 psi or greater, or of at least 500 psi or greater, or of at least 750 psi or greater, or of at least 1,000 psi or greater, or of at least 2,000 psi or greater, or of at least 3,000 psi or greater, or of at least 4,000 psi or greater, or of at least 5,000 psi or greater, or of at least 6,000 psi or greater, or of at least 7,000 psi or greater, or of at least 10,000 psi or greater, or of at least 15,000 psi or greater, or of at least 16,000 psi or greater. In some embodiments, the hollow glass microspheres have a crush strength from 250 psi to 30,000 psi. In some embodiments, the hollow glass microspheres have a crush strength from 500 psi to 30,000 psi. In some embodiments, the hollow glass microspheres have a crush strength from 750 psi to 30,000 psi. In some embodiments, the hollow glass microspheres have a crush strength from 1000 psi to 30,000 psi. In some embodiments, the hollow glass microspheres have a crush strength from 5000 psi to 30,000 psi. In some embodiments, the glass microspheres have a crush strength from 10,000 psi to 30,000 psi. In another embodiment, the hollow glass microspheres have a crush strength from 15,000 psi to 28,000 psi. In yet another embodiment, the hollow glass microspheres have a crush strength from 16,000 psi to 20,000 psi.

The low density, hollow glass microspheres in the present disclosure are chemically stable (e.g., in unmodified form), noncombustible, nonporous, and have excellent water resistance.

In some embodiments, the hollow glass microspheres suitable for use in the present disclosure have a density from about 0.1 to 0.7 g/cc, or from about 0.15 to 0.6 g/cc, or from about 0.2 to 0.6 g/cc, or from about 0.25 to 0.6 g/cc, or from about 0.25 to 0.5 g/cc, or from about 0.25 to 0.4 g/cc, or from about 0.1 to 0.2 g/cc, or from about 0.13 to 0.17 g/cc, or from about 0.18 to 0.22 g/cc, or from about 0.19 to 0.25 g/cc, or from about 0.23 to 0.27 g/cc, or from about 0.29 to 0.35 g/cc, or from about 0.32 to 0.38 g/cc, or from about 0.34 to 0.4 g/cc, or from about 0.35 to 0.41 g/cc, or from about 0.43 to 0.49 g/cc, or from about 0.57 to 0.63 g/cc, or from about 0.44 g/cc to 0.83 g/cc or from 0.10 to 0.60 g/cc. In some embodiments, the glass microspheres have a density from about 0.20 to 0.80 g/cc, from 0.30 to 0.60 g/cc, or about 0.15 to 0.60 g/cc, or about 0.4 to 0.5 g/cc, or about 0.2 to 0.6 g/cc, or about 0.15 to 0.6 g/cc. In some embodiments, the glass microspheres have a density from about 0.4 to 0.60 g/cc; from about 0.46 to 0.6 g/cc; or from about 0.45 to 0.6 g/cc.

In contrast, typical densities for other particulate matter, e.g., solid glass microspheres and titanium dioxide, are much higher than for the hollow glass microspheres as used in the permeable spreading layers of the disclosure, well over 1 g/cc and often over 2 g/cc. Colloids made from such particulate materials exhibit significant processing challenges, including poor particle dispersion within a colloid and poor particle suspension within a colloid, which results in creaming, settling and dusting due, e.g., to heterogeneous composition within a spreading layer. While reducing the particle size of such particulate matter helps alleviate the described challenges, smaller particles limit the maximum size of void space, further limiting the size and composition of liquid sample components that can move through the spreading layer.

In some embodiments, after the addition of the hollow glass microspheres to the binder and, optionally, one or more additional items as described herein, the density of the compounded product is about 1.2 g/cc or less, or about 1.1 g/cc or less, or about 1.0 g/cc or less, or about 0.95 g/cc or less, or about 0.90 g/cc or less, or about 0.85 g/cc or less, or about 0.80 g/cc or less, or about 0.75 g/cc or less, or about 0.70 g/cc or less, or about 0.65 g/cc or less, or about 0.6 g/cc or less, or about 0.55 g/cc or less, or between about 1.0 g/cc to 0.50 g/cc, or about 0.95 g/cc to 0.5 g/cc, or about 0.90 g/cc to 0.5 g/cc, or about 0.85 g/cc to 0.5 g/cc, or about 0.80 g/cc to 0.5 g/cc, or about 0.75 g/cc to 0.55 g/cc. Densities of combined particulate matter, binder and other optional ingredients as described herein typically have higher densities prior to the addition of hollow glass microspheres.

In some embodiments, the hollow glass microspheres have a density from 0.10 to 0.63 g/cc; a particle size from 5 to 150 μm; and a crush strength of at least 250 psi. In some one embodiments, the hollow glass microspheres have a density of at least 0.3 g/cc; a particle size from about 25 to 60 μm; and a crush strength of at least 500 psi. In some one embodiments, the hollow glass microspheres have a density of at least 0.35 g/cc; a particle size from about 30 to 55 μm; and a crush strength of at least 500 psi. In some embodiments, the hollow glass microspheres have a density of at least 0.35 g/cc; a median particle size of about 35 μm; and a crush strength of at least 1,000 psi.

### Reflectivity

When optical detection of color or fluorescence is desired, high reflectance of the slide is a critical parameter to increase response and decrease optical variation (noise). Not only is reflectance of the dry slide important, but equally, if not more important, is the reflectance properties of the wet slide after sample application as well as the difference between the two measurements. In the dry slide, reflectance is typically higher due to the voids that exist between the particles. When sample is applied, these voids are filled and the optical properties of the particles in the spreading layer control the reflectance. Table 1 shows the differences in reflectance values for two types of hollow glass microspheres as well as for two other types of microspheres with less desirable optical properties.

TABLE 1
Reflectance properties of dry slides made with various
types of particles in the permeable spreading layer

| | Dry % | Wet % | Δ % |
|---|---|---|---|
| | reflectance | reflectance | Reflectance |
| Hollow glass microsphere type 1, | 73% | 62% | −11% |
| 200 μm dry thickness | | | |
| Hollow glass microsphere type 2, | 72% | 59% | −13% |
| 200 μm dry thickness | | | |
| Expanded glass microspheres, | 66% | 46% | −20% |
| 200 μm dry thickness | | | |
| Polystyrene microspheres, | 62% | 39% | −23% |
| 200 μm dry thickness | | | |

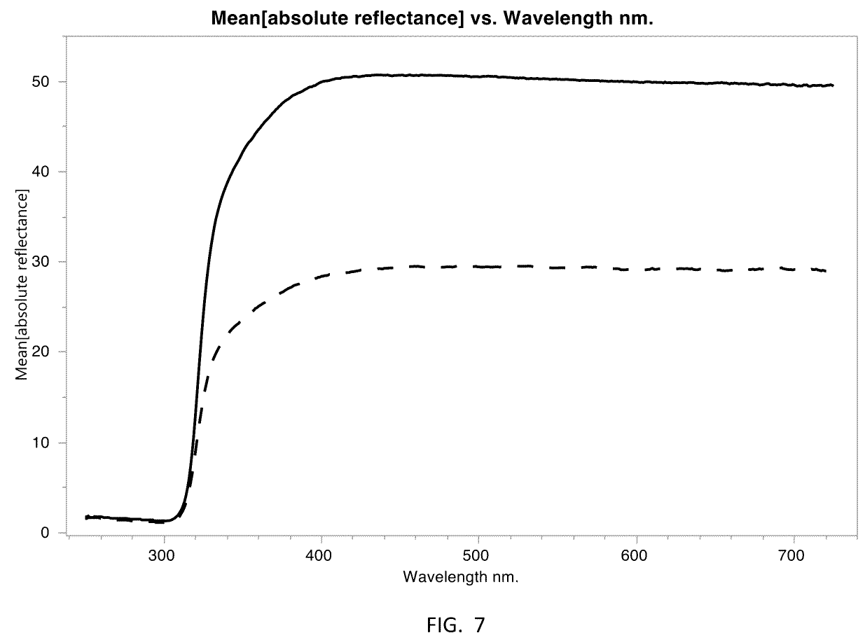

Similarly, FIG. 7 shows a graph of the mean absolute reflectance of an exemplary sample of the coated spreading layer containing hollow glass microspheres (solid line) as compared to an exemplary sample of the coated spreading layer with crosslinked polystyrene microspheres (dashed line), demonstrating substantially higher reflectivity over a range of wavelengths.

In some embodiments, the permeable spreading layer has a dry percent reflectance of at least about 65%, or at least about 66%, or at least about 67%, or at least about 68%, or at least about 69%, or at least about 70%, or at least about 71%, or at least about 72%, or at least about 73%, or at least about 74%, or at least about 75%, or at least about 76%, or at least about 77%, or at least about 78%, or at least about 79%, or at least about 80%, or at least about 81%, or at least about 82%, or at least about 83%, or at least about 84%, or at least about 85%, or at least about 86%, or at least about 87%, or at least about 88%, or at least about 89%, or at least about 90%, or at least about 95%, or between about 65% and 95%, or between about 65% and 90%, or between about 65% and 85%, or between about 65% and 80%, or between about 65% and 75%, or between about 70% and 95%, or between about 70% and 90%, or between about 70% and 85%, or between about 70% and 80%, as measured in the absence of, or in some embodiments the presence of, one or more pigments, such as, talc, silicon dioxide, titanium dioxide, calcium carbonate, barium sulfate, kaolin, wollastonite, and mica.

In some embodiments, the permeable spreading layer has a wet percent reflectance of at least about 50%, or at least about 55%, or at least about 60%, or at least about 65%, or at least about 70%, or at least about 75%, or at least about 80%, or at least about 85%, or at least 90%, or between about 50% and 95%, or between about 55% and 90%, or between about 55% and 85%, or between about 55% and 80%, or between about 55% and 75%, or between about 55% and 70%, or between about 55% and 65%, or between about 60% and 95%, or between about 60% and 90%, or between about 60% and 85%, or between about 60% and 80%, or between about 60% and 75%, or between about 60% and 70%, or between about 60% and 65%, as measured in the absence of, or in some embodiments the presence of, one or more pigments.

### Buffers

In some embodiments, permeable spreading layers can include one or more buffers. In some embodiments, the buffer is a basic buffer, which in some embodiments has a pH is between about pH 7 to pH 10, pH 7 to pH 9, pH 7 to pH 8, pH 8 to pH 10, pH 8 to pH 9, pH 7.5 to pH 10, pH 7.5 to pH 9.5, pH 7.5 to pH 9, pH 7.5 to pH 8.5, pH 8 to pH 10, pH 8 to pH 9.5, pH 8 to pH 9, or about any one of pH 7, pH 7.5, pH 8, pH 8.4, pH 9, pH 9.5 or pH 10. In some embodiments, permeable spreading layers are dried in a buffer of between about pH 7-9.

Suitable basic buffers include, for example, MOPS (3-(N-morpholino) propanesulfonic acid), HEPES (4-(2-hydroxyethyl)-1-piperazineethanesulfonic acid), TES (N. Tris(hydroxymethyl)methyl-2-aminoethanesulfonic acid), MOBS (4-(N-Morpholino) butanesulfonic acid), DIPSO (3-(N,N-Bis [2-hydroxyethyl]amino)-2-hydroxypropanesulfonic acid), TAPSO (N-[Tris(hydroxymethyl)methyl]-3-amino-2-hydroxypropanesulfonic acid), TEA (triethanolamine), pyrophosphate (pKa₄), HEPPSO (N-(2-Hydroxyethyl)piperazine-N′-2-hydroxypropanesulphonic acid), POPSO (Piperazine-N,N′-bis(2-hydroxypropanesulfonic acid)), tricine, hydrazine, glycylglycine (pKa₂), Trizma (tris), EPPS (N-(2-Hydroxyethyl)piperazine-N′-(3-propanesulfonic acid)), HEPPS (4-(2-Hydroxyethyl)piperazine-1-propanesulfonic acid), bicine (N,N-Bis(2-hydroxyethyl)glycine), HEPBS (4-[4-(2-Hydroxyethyl)piperazin-1-yl]butane-1-sulfonic acid), TAPS (3-{[1,3-Dihydroxy-2-(hydroxymethyl) propan-2-yl]amino}propane-1-sulfonic acid), AMPD (2-amino-2-methyl-1,3-propanediol), TABS (N-Tris(hydroxymethyl)methyl-4-aminobutanesulfonic acid), AMPSO (N-(1,1-Dimethyl-2-hydroxyethyl)-3-amino-2-hydroxypropanesulfonic acid), taurine (AES), borate (pKa₁, pKa₂, or pKa₃), CHES (2-(Cyclohexylamino) ethane-1-sulfonic acid), AMP (2-amino-2-methyl-1-propanol), glycine (pKa₂), ammonium hydroxide, CAPSO (3-(cyclohexylamino)-2-hydroxy-1-propanesulfonic acid), carbonate (pKa₂), methylamine, piperazine (pKa₂), CAPS (3-(Cyclohexylamino)-1-propanesulfonic acid), and others suitable in supporting biological reactions at basic pH levels. pKa₁ represents the negative base-10 logarithm of the first (lowest) acid dissociation constant (Ka) of a solution; pKa₂ (pKa₃, etc.) represents the negative base-10 logarithm of the second (third, etc.) acid dissociation constant (Ka) of a solution where two (three, etc.) dissociations can occur. Suitable pH buffering behavior is generally observed within +/−1 unit of a pKa value; thus, buffers with pKa values at or above 7 can be suitable for permeable spreading layers.

In particular embodiments, the permeable spreading layer includes bicine buffer at pH 8.4. Generally, the amount of basic buffer substance is from 1 to 50 mg/ml, for example 5 to 45 mg/ml, 10 to 30 mg/ml or 15 to 25 mg/ml.

In some embodiments, permeable spreading layers further include an acidic buffer. In some embodiments the pH is between about pH 1 to pH 6, pH 1 to pH 5, pH 2 to pH 7, pH 2 to pH 6, pH 3 to pH 6, pH 4 to pH 6, pH 2 to pH 5, pH 3 to pH 5, pH 2.5 to pH 5.5, pH 2.5 to pH 5, pH 2.5 to pH 4.5, pH 3 to pH 5.5, pH 3.5 to pH 5.5, pH 3.5 to pH 5, or about any one of pH 2.5, pH 3, pH 3.5, pH 4, pH 4.5, pH 5, pH 5.5 or pH 6. In particular embodiments, the pH is between about pH 3.5 to pH 4.5, and in other particular embodiments, the pH of the permeable spreading layer is about pH 4.

Suitable acidic buffers include, for example, maleate (pKa₁), phosphate (pKa₁), glycine (pKa₁), citrate (pKa₁), glycylglycine (pKa₁), malate (pKa₁), formate, citrate (pKa₂), succinate (pKa₁), acetate, propionate, malate (pKa₂), pyridine, piperazine (pKa₁), cacodylate, succinate (pKa₂), MES (2-(N-morpholino) ethanesulfonic acid), citrate (pKa₃), maleate (pKa₂), bis-tris, carbonate (pKa₁), PIPES (piperazine-N, N′-bis(2-cthanesulfonic acid), ACES (N-(2-Acetamido)-2-aminoethanesulfonic acid), tartrate, and others suitable in supporting biological reactions at acidic pH levels. As suitable pH buffering behavior is generally observed within +/−1 unit of a pKa value; thus, buffers with pKa values below 7 can be suitable for permeable spreading layers. Generally, the amount of acidic buffer substance is from 1 to 50 mg/ml, for example 5 to 45 mg/ml, 10 to 30 mg/ml or 15 to 25 mg/ml.

### Additional Voiding Agents

In some embodiments of the present disclosure, permeable spreading layers may further comprise additional voiding agents dispersed therein. In one embodiment, suitable additional voiding agents include at least one polymer selected from acrylic polymers, cellulosic polymers, starch, esterified starch, polyketones, polyester, polyamides, polysulfones, polyimides, polycarbonates, olefinic polymers, and copolymers thereof. The term “olefinic polymer”, as used herein is intended to mean a polymer resulting from the addition polymerization of ethylenically unsaturated monomers such as, for example, polyethylene, polypropylene, polystyrene, poly(acrylonitrile), poly(acrylamide), acrylic polymers, poly(vinyl acetate), poly(vinyl chloride), and copolymers of these polymers. The additional voiding agent may also comprise one or more inorganic compounds, including pigments, such as, talc, silicon dioxide, titanium dioxide, calcium carbonate, barium sulfate, kaolin, wollastonite, and mica. The additional voiding agent also may comprise a combination of polymeric and inorganic materials.

### Surfactants

In some embodiments, permeable spreading layers further include one or more surfactants. Surfactants can be effective, e.g., in normalizing liquid transport in the permeable spreading layer. Normalizing liquid transport refers to obtaining within the permeable spreading layer an equivalent penetration of the solvent medium and dissolved components of various applied samples of aqueous proteinaccous liquids, notwithstanding variations in protein concentration between such samples.

A broad variety of ionic and nonionic surfactants can be useful. Suitable surfactants include those which possess hydrophilic-lipophilic balance (HLB) in the range between about 6 and 15. HLB is a measure of its degree of hydrophilicity or lipophilicity, determined by calculating percentages of molecular weights for the hydrophilic and lipophilic portions of the surfactant molecule according to the formula HLB=20*Mₕ/M where Mₕ is the molecular mass of the hydrophilic portion of the molecule, and M is the molecular mass of the whole molecule, giving a result on a scale of 0 to 20. An HLB value of 0 corresponds to a completely lipophilic/hydrophobic molecule, and a value of 20 corresponds to a completely hydrophilic/lipophobic molecule. Suitable surfactants may have a carboxyl group, a sulfonic acid group, a sulfate group or a phosphate as a hydrophilic group. Anionic surfactants having a sulfonic acid group include alkylbenzenesulfonate (e.g., sodium dodecylbenzenesulfonate; SDBS), alkylnaphthalenesulfonate, alkylsulfate, a polyoxyethylene alkyl ether sulfate, α-olefin sulfonate, and N-acylmethyl taurine salts.

In some embodiments, the surfactant is an alkylbenzenesulfonate with an alkyl chain containing 10 to 14 carbon atoms, and in some embodiments, sodium dodecylbenzenesulfonate is used. As a salt, a sodium salt is most common; however, potassium salts or lithium salts can also be used.

In some embodiments, the one or more surfactants comprise non-ionic surfactants, such as ethoxylates, fatty alcohol ethoxylates, alkylphenol ethoxylates (APEs or APEOs), fatty acid ethoxylates, ethoxylated amines and/or fatty acid amides, terminally blocked ethoxylates, fatty acid esters of polyhydroxy compounds, fatty acid esters of glycerol, fatty acid esters of sorbitol, fatty acid esters of sucrose, alkyl polyglucosides, and the like.

In some embodiments, the non-ionic surfactant is soluble in a polar solvent, which in some embodiments is an alcohol, e.g., methanol, ethanol, n-propanol, isopropanol, n-butanol, and the like.

In some embodiments, one or more surfactants can be included in the permeable spreading layer in an amount effective to normalize spreading within the layer. This is usually from about 1 percent to about 15 percent. Unless expressly identified to the contrary, reference herein to percentage concentrations means percent by weight of total solids within the layer in which the designated item is located. Preferably, surfactant is provided in the permeable spreading layer in an amount of about 0.5 percent to about 10 percent and most preferably from about 1 percent to about 5 percent. In calculating the surfactant concentration, adjustment should be made for non-active ingredients in any surfactant composition. Expressed in terms of coverage, surfactant concentrations usually range from about 0.5 to about 5 grams per square meter.

### Viscosity Modifiers

In some embodiments, a viscosity modifier can be employed to increase viscosity and to provide additional suspension for particles. Suitable agents include cellulose and cellulose derivatives (e.g. carbodymethyl cellulose, hydroxypropyl cellulose, hydroxypropyl methyl cellulose), acrylic-based alkali swellable polymers, and non-ionic polyurethane or polyethylene associative thickeners. In particular embodiments, the polymeric spreading layer includes carboxymethyl cellulose.

### Plasticizers

In some embodiments, a plasticizer can be employed to increase the flexibility of the coating. Plasticizers are characterized as low molecular weight polymers that are compatible with the solvent system of choice and reduce the T_{g} of the primary binder. Suitable agents for this application include low molecular polyethylene glycol (e.g. PEG-200 to PEG-6000), dicarboxylic acid esters (e.g. citric acid ester), fatty acid esters, polypropylene and polyethylene glycol phenyl ethers. In particular embodiments, one or more of PEG 200 through PEG 600 are included, and in other embodiments, one or more of PEG 200 through 400 are included, and in some embodiments PEG 200, PEG 300, or PEG 400 is included, and in some embodiments, PEG 300 is included.

### Biocides

In some embodiments, a biocidal agent can be employed to preserve the coating and protect against microbial contamination. Suitable biocides include those in the isothiazoline family (trade names ProClin™ and Kathon™) as well as other preservatives known to provide biocidal action such as sodium azide. In certain embodiments, one or more of ProClin 150, ProClin 200, ProClin 300, or ProClin 950 is included, and in some embodiments ProClin 200 or ProClin 300 is included, and in some embodiments ProClin 300 is included.

### Defoaming Agents

In some embodiments, a defoaming agent can be employed to mitigate entrained air in the coating formulation to improve coatability and coating quality. Examples of defoaming agents include mineral oil or silicone emulsions in water or polyether based preparations.

### Uses

Permeable spreading layers of the disclosure can be adapted for use in a wide variety of chemical analyses, e.g., from clinical chemistry to chemical research and chemical process control laboratories. Such spreading layers are well suited for use in clinical testing of body fluids (e.g., blood, blood serum, urine) where multiple repetitive tests are frequently conducted and rapid test results are often needed.

In the field of blood analysis, for example, one or more permeable spreading layers can be combined with one or more functional layers to make a multilayer dry chemistry analytical element, which can be adapted for use in carrying out quantitative analyses for one or more analytes found in blood. Thus, for example, the analytical element may be readily adapted for use in the analysis of such blood components as albumin, alkaline phosphatase, alanine transaminase (ALT), amylase (AMYL), aspartate (amino) transferase (AST), bile acids, total bilirubin (TBIL), blood urea nitrogen (BUN), calcium, cholesterol, creatine kinase (CK), creatine, C-reactive protein (CRP), fructosamine (FRU), gamma-glutamyl transferase (GGT), glucose, potassium, Lactic acid (LAC), lactate dehydrogenase (LDH), lipase (LIPA), magnesium, sodium, ammonia, phenobarbital (PHBR), phosphate (PHOS), progesterone (PROG), symmetrical dimethylarginine (SDMA), total protein (TP), triglycerides (TRIG), total thyroxine 4 (TT4), as well as many other components, by appropriate choice of test reagents or other interactive materials added to one or more layers, including the permeable spreading layer(s). Analogous arrangements of suitable layers can be made for other fluids, whether biological or non-biological.

In analyzing blood with a dry chemistry analytical element of the disclosure, blood cells may first be separated from the serum, e.g., by centrifuging, and the serum applied to the analytical element. However, it is not always necessary to make such separation, for example, when reflective spectrophotometric analysis techniques are used to quantify or otherwise analyze one or more analytes in the sample, whether such analytes are detected directly or detected indirectly via a detectable species in a layer of the analytical element that responds proportionately to the amount of analyte in the sample.

One or more liquid samples can be applied directly to a top layer of the dry chemistry analytical element, which top layer in some embodiments is a permeable spreading layer. A permeable spreading layer, however, need not be the top-most layer in an analytical element. One or more functional layers that provide other functions, e.g., liquid sample (pre-) filtering (e.g., size exclusion to remove larger sample components, or chemical or biological-based filtering to, e.g., remove inhibitory or interfering compounds), sample reagent supplementation, and the like, may be positioned above (superior to) a permeable spreading layer.

The present analytical elements are used by applying to the top layer of the analytical element a sample of liquid to be analyzed. In some embodiments, a permeable spreading layer is positioned as the top layer of an analytical element, and thus an applied sample will contact the spreading layer prior to any other functional layer below (inferior to) the spreading layer. Analytical accuracy of the analytical elements described herein is not substantially diminished by variations in the volume of applied samples when a permeable spreading layer is present in the analytical element. Consequently, sample application by hand or machine is generally acceptable.

In an exemplary analytical procedure using the permeable spreading layer(s) of the disclosure, an analytical element is positioned to receive a volume of sample (e.g., one or more drops) from a dispenser (e.g., hand pipette or automated dispenser within an automated analyzer). After application of the sample and, if the permeable spreading layer is not the top-most layer, reception of the sample by a permeable spreading layer, the analytical element is exposed to any conditioning (e.g., temperature regulation, humidification or the like) that may be desirable to standardize, quicken or otherwise facilitate obtaining any test result. The sample is spread, mixed and/or metered by the spreading layer to the functional layer below, and in fluid contact with, the spreading layer. This can be accomplished conveniently by appropriate selection of various parameters, such as layer thickness, void volume, and the like.

After the analytical result is obtained as a detectable change, it is measured, usually by passing the analytical element through a zone in which suitable apparatus for reflection spectrophotometry is provided. Such apparatus would serve to direct a beam of energy, such as light, through the (optically transparent) support and the functional layer comprising the detectable species. The light would then be reflected by the permeable spreading layer, which is demonstrates high reflectance, back to a detecting means. Use of reflection spectrophotometry can be advantageous in some situations as it can effectively avoid interference from residues, such as blood cells, which may have been left on or in layers of the analytical element. Generally, electromagnetic radiation in the range of from about 200 to about 900 nm has been found useful for such measurements, although any radiation to which the analytical element is permeable and which is capable of quantifying the product produced in the element can be used. Various calibration techniques can be used to provide a control for the analysis. As one example, a sample of analyte standard solution can be applied adjacent to the area where the drop of sample is placed in order to permit the use of differential measurements in an analysis.

As can be appreciated, layers (permeable spreading layers and other functional layers) and analytical elements comprising such layers can be configured in a variety of forms, including coated on slides, as cartridges for use with automated chemical analyzers or instruments, as elongated tapes of any desired width, as sheets or as chips, and the like. Particular analytical elements can be adapted for one or more tests of a single type (i.e., one analyte), or one or more tests of a variety of different test types. In embodiments of the former comprising multiple tests of the same analyte, a common support can be coated with one or more strips or channels, each of the same composition to form a composite analytical element suited to conducting a test on multiple liquid samples in parallel (multiplexing). In such latter embodiments, a common support can be coated with one or more strips or channels, each optionally of a different composition to form a composite analytical element suited for conducting a variety of different tests.

In some embodiments one or more permeable spreading layers is combined with one or more functional layers (e.g., e.g., reagent layer, filter layer, isolation layer, indicator layer, physical support layer, and the like) to make a dry chemistry analytical element. In embodiments, the dry chemistry analytical element further includes a support layer that provides a rigid or semi-rigid physical foundation for the layers of the analytical element.

In some embodiments, the support layer is optically transparent and impermeable to aqueous liquids, examples of which include film- or sheet-type transparent supports having a thickness of, e.g., 50 μm to 5 mm and comprising materials, in some embodiments, polymers such as polyethylene terephthalate (PET), polycarbonate of bisphenol A, polystyrene, cellulose ester (e.g., cellulose diacetate, cellulose triacetate, or cellulose acetate propionate), or the like, or other suitable materials such as glass. In some embodiments, the support layer is PET.

A support layer of choice for any particular analytical element will be compatible with the intended mode of result direction. Preferred supports include radiation-transmissive support materials that transmit electromagnetic radiation of a wavelength or wavelengths within the region between about 200 nm and about 900 nm.

The components of any particular layer of an analytical element, and the layer order or configuration of choice, depends on the use for which an analytical element is intended. As stated previously, permeable spreading layer pore size can be chosen so that the permeable layer can filter out undesirable sample components that would, for example, interfere with analytical reaction or with the detection of any test result produced within the analytical element. For example, for analysis of whole blood, permeable layers having a pore size of from 1 to about 5 microns are useful in screening out blood cells, which typically have a size of from about 7 to about 30 microns. If desirable, an analytical element can include a plurality of permeable spreading layers, each of which may be different in its ability to spread, mix, meter and filter a sample. Also, if a restraint on transport of substances within the permeable layer beyond that provided by the permeable layers is needed, a filter or dialysis layer can be included at an appropriate location in the analytical element.

In some embodiments, the analytical element also includes a primer layer on the support layer that facilitates and/or enhances the binding of the other layers of the analytical element to the support layer. Alternatively, or in addition, physical or chemical activation treatment can be carried out on the support layer surface such to enhance adhesivity.

In some embodiments, the primer layer includes a hydrogel, which is a crosslinked, three-dimensional hydrophilic network that has the ability to swell but resist dissolving when placed in water or other biological fluid, such as D4 hydrogel. In some embodiments, the primer layer also includes a support matrix like cellulose and/or cellulose derivatives (e.g., carboxymethylated cellulose, methylated cellulose, hydroxyethylated cellulose, and hydroxypropylated cellulose). In some embodiments, the primer layer includes D4 hydrogel and cellulose.

### EXAMPLES

### Example 1-Mercury Intrusion Porosimetry (MIP)

Mercury intrusion porosimetry (MIP) was utilized to measure the total pore area, median pore size, total intrusion volume, bulk density, apparent density and percent porosity of two samples, one with the coated spreading layer applied over the PET substrate (DuPont “Melinex”) and the other the PET substrate alone.

The pore size distribution and porosity analysis of the samples were conducted on a mercury intrusion porosimeter, which measures the volume of mercury, a non-wetting liquid, as it intrudes into a sample at increasing pressures to probe increasingly smaller pores. The Washburn equation, was used to calculate the inner equivalent cylindrical pore diameter based on the pressure applied.

$${d}_{i} = \frac{( Washcon ) ( γ ) ( - 4 cos θ )}{{P}_{i}}$$

where dᵢ is the cylindrical equivalent pore diameter for the i^{th} point, Washcon is the Washburn constant

$$( \frac{{10}^{4} μm / cm}{( 68947.7 dynes / {cm}^{2} ) ( psia )} ) ,$$

γ is the surface tension, θ is the contact angle and Pi is the applied pressure. Other parameters, such as total pore area, median pore size, total intrusion volume, bulk density, apparent density and percent porosity, can then be derived as is known in the art.

One strip of PET coated with the spreading layer formulation, measuring 2 cm×10 cm was used for analysis, and two strips of the substrate PET, measuring 2 cm×10 cm were used for analysis. The experiments were conducted over a working range of approximately 0.1 psia to about 61,000 psia (or over a pore size range of approximately 0.004 μm to 200 μm). A contact angle of 140° was used. For the PET coated with the spreading layer formulation, the following additional experimental parameters and detailed results apply: sample mass: 0.4276 g; stem volume used: 64%; mercury temperature: 20.83° C.; assembly mass: 134.2171 g; penetrometer volume: 5.6721 mL; total intrusion volume at 50,148.80 psia: 0.5770 mL/g; total pore area at 50,148.80 psia: 69.475 m²/g; median pore diameter (volume) at 51.35 psia and 0.289 mL/g: 4.19750 μm; median pore diameter (area) at 18,675.40 psia and 34.737 m²/g: 0.01154 μm; average pore diameter (4V/A): 0.03322 μm; bulk density at 1.02 psia: 0.7961 g/mL; apparent (skeletal) density at 50,148.80 psia: 1.4726 g/mL; and porosity: 45.9385%.

For the substrate PET the following additional experimental parameters and detailed results apply: sample mass: 0.8055 g; stem volume used: 30%; mercury temperature: 21.06° C.; assembly mass: 132.6949 g; penetrometer volume: 5.6721 mL; total intrusion volume at 50,149.97 psia: 0.1420 ml/g; total pore area at 50,149.97 psia: 10.064 m²/g; median pore diameter (volume) at 8.14 psia and 0.071 mL/g: 26.48438 μm; median pore diameter (area) at 32,890.00 psia and 5.032 m²/g: 0.00655 μm; average pore diameter (4V/A): 0.05644 μm; bulk density at 1.02 psia: 1.1823 g/mL; apparent (skeletal) density at 50,149.97 psia: 1.4208 g/mL; and porosity: 16.7894%.

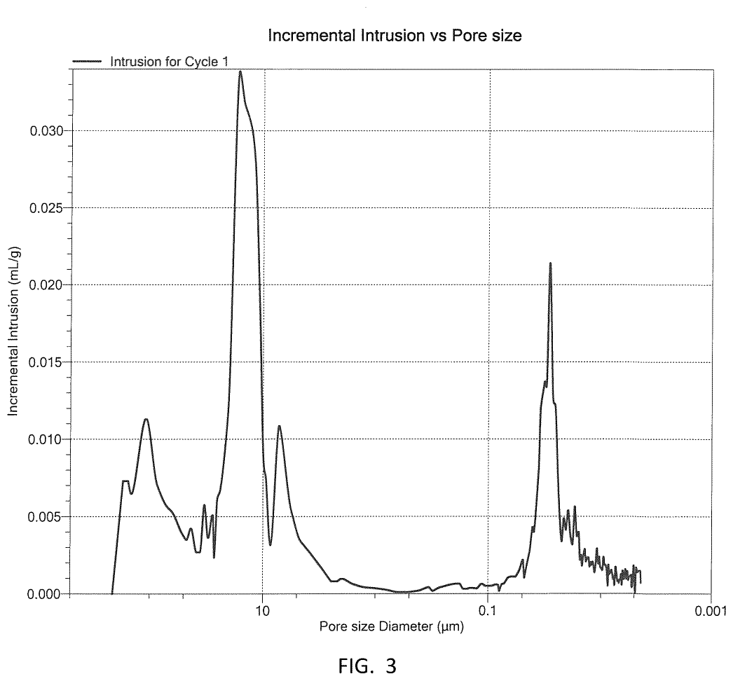

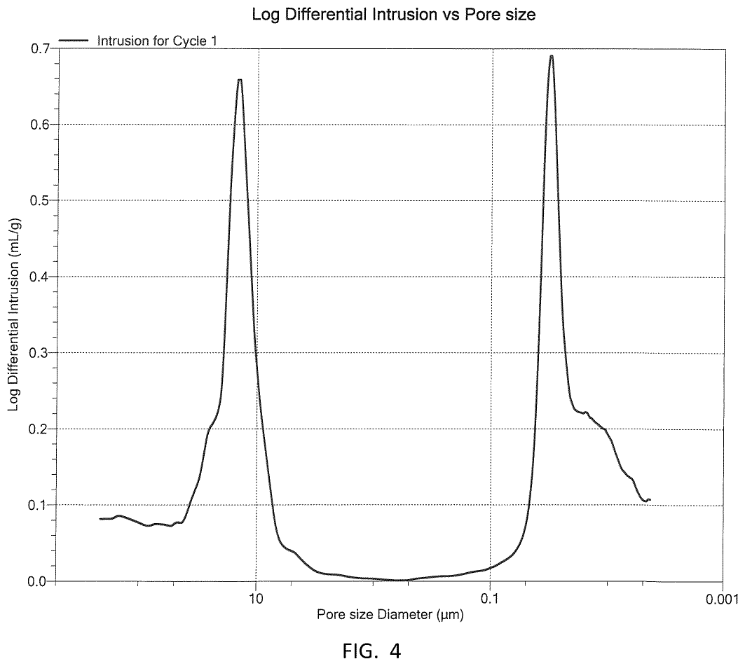

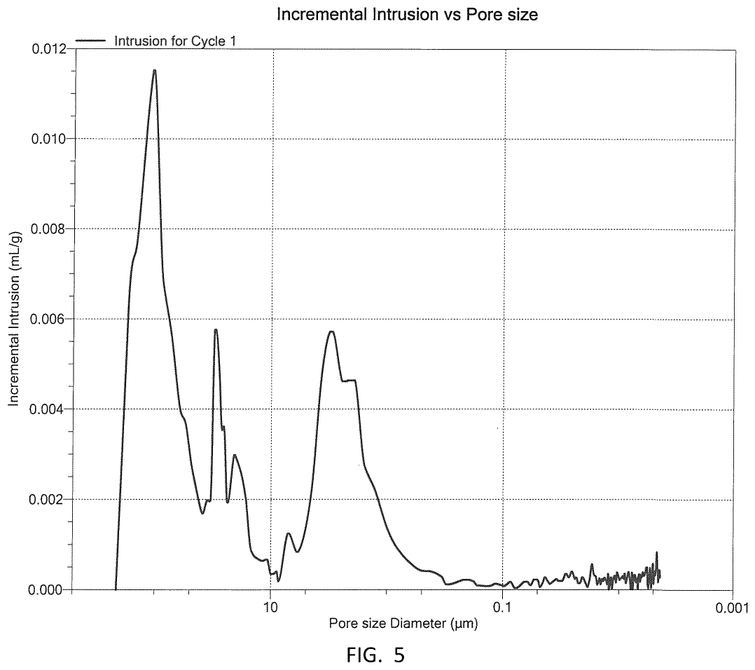

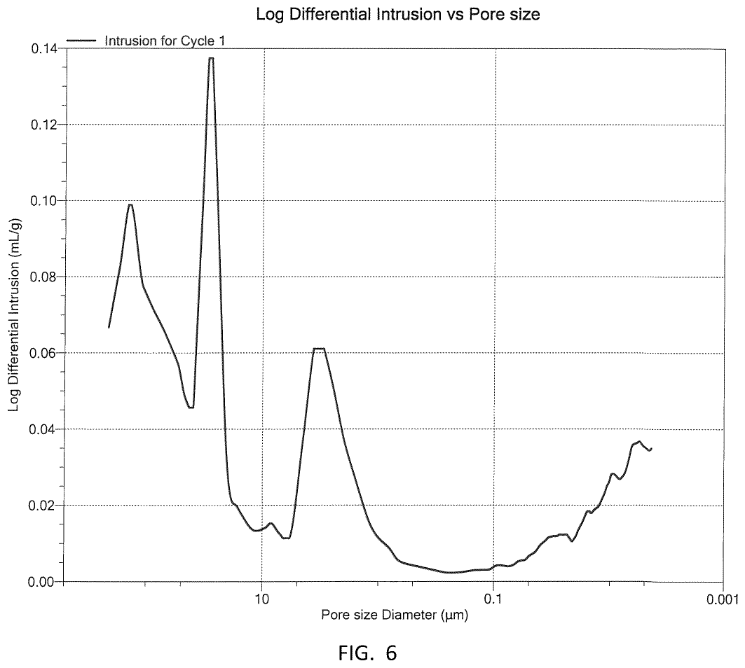

Summary results of MIP are shown in Table 2 below, and FIGS. 3-12.

TABLE 2
Mercury intrusion porosimetry data summary

| | | | Volume | | | |
|---|---|---|---|---|---|---|
| | Total | Total | medial | | | |
| | intrusion | pore | pore | Bulk | Apparent | |
| | volume | area | diameter | density | density | Percent |
| Sample ID | (mL/g) | (m²/g) | (μm) | (g/mL) | (g/mL) | porosity |
| PET | 0.58 | 69.48 | 4.20 | 0.80 | 1.47 | 45.9 |
| (Melinex) | | | | | | |
| coated | | | | | | |
| with a sample | | | | | | |
| spreading | | | | | | |
| layer | | | | | | |
| PET | 0.14 | 10.06 | 26.48 | 1.18 | 1.42 | 16.8 |
| (Melinex) | | | | | | |
| uncoated | | | | | | |

### Example 2 Formulation of a Spreading Layer Containing Hollow Glass Microspheres

To prepare a spreading layer formulation, 111 g of 250 mM HEPES buffer, 205 g of 1% carboxymethyl cellulose solution (750 k MW), 25 g DI water, and 2.238 g. of PEG 300 were added to a 500 mL glass vessel. This mixture was agitated using a pitched-blade impeller in an overhead mixer with a speed of 200 rpm. Once homogenized, 200 g of hollow glass microspheres having a bulk density of approximately 0.45 g/cm³ were slowly added over the course of 10-15 minutes while mixing at 500 rpm. Once combined, 32 g of emulsified acrylic binder (Hycar® FF 26916, Lubrizol) was added to the mixture and allowed to mix for approximately 5 minutes. After the binder was fully incorporated, the mixing speed was reduced to 100 rpm and 22.08 g of 10% SDBS solution was added and allowed to mix for 5 more minutes.

### Example 3-Application of Spreading Layer Formulation

Once prepared, the spreading layer formulation can be applied to suitable substrates using various coating application techniques. In one example, the spreading layer formulation was applied on top of previously coated and dried layer(s) containing a lipid substrate suited for the detection of pancreatic lipase. Using a slot-die coating applicator, the spreading layer formulation was metered into the slot die by a piston pump and applied to the previously coated layers at a wet thickness of approximately 200 μm. Upon drying, the spreading layer forms a continuous opaque and reflective coated surface that absorbs, spreads and transmits liquid samples to the reagent-containing layers below.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims. In addition, the section headings used herein are for organizational purposes only and are not to be construed as limiting the subject matter described.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise.

The present disclosure shall control in the event there are any disparities between any definitions and/or description found in the cited references.

1. A permeable spreading layer comprising:
hollow glass microspheres; and
a polymeric binder;
wherein the permeable spreading layer has high reflectivity and low density.

2. The permeable spreading layer of claim 1, wherein the polymeric binder comprises an emulsified polymer or copolymer with adhesive properties.

3. The permeable spreading layer of claim 1, wherein the hollow glass microspheres have a diameter from about 1 μm to about 100 μm.

4. The permeable spreading layer of claim 1, wherein the polymeric spreading layer has a dry reflectivity of at least about 65%, at least about 70%, at least about 75%, at least about 80%, or at least about 85%.

5. (canceled)

6. The permeable spreading layer of claim 1, wherein the polymeric spreading layer has a wet reflectivity of at least about 50%, at least about 55%, at least about 60%, at least about 65%, at least about 70%, at least about 75%, or at least about 80%.

7. (canceled)

8. The permeable spreading layer of claim 1, wherein the polymeric spreading layer has a density of less than about 1.0 g/cc, less than about 0.9 g/cc, less than about 0.85 g/cc, less than about 0.80 g/cc, less than about 0.75 g/cc, or less than about 0.7 g/cc.

9. (canceled)

10. The permeable spreading layer of claim 1, wherein the polymeric spreading layer has an average void volume of between about 10 percent to about 80 percent.

11. (canceled)

12. The permeable spreading layer claim 1, wherein the hollow glass microspheres have a crush strength of at least 250 psi, or have an average particle size of about 5 μm to 180 μm, or a density of 0.15 g/cc to 0.83 g/cc.

13. (canceled)

14. The permeable spreading layer of claim 1, wherein the hollow glass microspheres have a crush strength of at least 500 psi, or have an average particle size of 20 μm to 65 μm, or a density of 0.3 g/cc to 0.6 g/cc.

15. (canceled)

16. The permeable spreading layer of claim 1, wherein
the polymeric binder comprises between about 0.1-10 wt % of a polymer composition comprising one or more acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, styrene butadiene copolymers or blends, polyethylene, ethylene/propylene copolymer, ethylene-vinyl acetate (EVA), ethylene vinyl alcohol copolymer, polyvinylpyrrolidone, polyurethanes, poly(lactic acid), copolyesters, and mixtures thereof; and
the hollow glass microspheres are present at between about 1-80 wt %.

17. (canceled)

18. The permeable spreading layer of claim 16, wherein
the polymeric binder is present at between about 2-8 wt %; and
the hollow glass microspheres are present at between about 20-50 wt %.

19. (canceled)

20. The permeable spreading layer of claim 16, wherein
the polymeric binder comprises acrylic polymers, polyvinyl acetate (PVA) polymers, ethylene-vinyl acetate (EVA) polymers, PVA-EVA copolymers, styrene butadiene copolymers, or mixtures thereof, and is present at between about 5-6 wt %; and
the hollow glass microspheres are present at between about 30-40 wt %.

21. The permeable spreading layer of claim 1, wherein
the polymeric binder comprises a polymer composition comprising one or more acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, styrene butadiene copolymers or blends, polyethylene, ethylene/propylene copolymer, ethylene-vinyl acetate (EVA), ethylene vinyl alcohol copolymer, polyvinylpyrrolidone, polyurethanes, poly(lactic acid), copolyesters, and mixtures thereof;
the hollow glass microspheres are present at between about 1-80 wt %; and
the pigment volume concentration (PVC) is between about 87% to 97%.

22. (canceled)

23. (canceled)

24. The permeable spreading layer of claim 21, wherein
the hollow glass microspheres are present at between about 25-45 wt %; and
the pigment volume concentration (PVC) is between about 87% to 97%.

25. (canceled)

26. The permeable spreading layer of claim 21, wherein
the polymeric binder comprises one or more acrylic polymers, acrylic copolymers or mixtures thereof;
the hollow glass microspheres are present at between about 30-40 wt %; and
the pigment volume concentration (PVC) is between about 90% to 95%.

27. The permeable spreading layer of claim 1, further comprising one or more buffers.

28. (canceled)

29. The permeable spreading layer of claim 27, wherein the buffer comprises one or more of bicine buffer or HEPES buffer.

30. The permeable spreading layer of claim 1, further comprising one or more surfactants.

31. The permeable spreading layer of claim 1, further comprising one or more plasticizers.

32. The permeable spreading layer of claim 31, wherein the one or more plasticizers comprises PEG.

33. (canceled)

34. The permeable spreading layer of claim 1, further comprising one or more biocides.

35. The permeable spreading layer of claim 1, further comprising one or more defoamer.

36. The permeable spreading layer of claim 1, further comprising one or more voiding agents.

37. The permeable spreading layer of claim 36, wherein the voiding agent comprises a pigment.

38. The permeable spreading layer of claim 1, wherein the layer has a thickness of between about 100 μm to about 500 μm, or about 100 μm to about 400 μm or about 100 μm to about 300 μm.

39. The permeable spreading layer of claim 1, wherein the spreading layer is isotropically porous.
